(19) United States
(12) Patent Application Publication
(10) Pub. No.: US 2016/0138948 A1
(43) Pub. Date: May 19, 2016

(54) DOWNHOLE OIL WELL SENSOR HOUSING HAVING A COMPRESSION SEAL ASSEMBLY

(71) Applicant: AK Research LLC, Bartlesville, OK (US)

(72) Inventor: Leroy David Cordill, Bartlesville, OK (US)

(21) Appl. No.: 14/546,532

(22) Filed: Nov. 18, 2014

(51) Int. Cl. G01D 11/26; E21B 47/00; G01D 11/24

(52) U.S. Cl. CPC G01D 11/26; G01D 11/245; E21B 47/00

(57) ABSTRACT

The invention relates generally to a downhole oil well sensor housing having a compression sealing assembly that is responsive to the external pressures within a subterranean bore-hole. The downhole oil well sensor housing has a sealing assembly configured to provide a compression seal around individual signal wires coupled to a downhole measurement sensor retained within the sensor housing. The downhole measurement sensor is secured within one end of the sensor housing, while the sealing assembly is secured within the opposing end of the sensor housing.

### CROSS REFERENCE TO RELATED APPLICATIONS

Not Applicable.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### REFERENCE TO A SEQUENCE LISTING, A TABLE, OR A COMPUTER PROGRAM LISTING APPENDIX

Not Applicable.

### STATEMENT REGARDING PRIOR DISCLOSURES BY THE INVENTOR OR A JOINT INVENTOR

Not Applicable.

### BACKGROUND OF THE INVENTION

1. Field of the Invention

This invention relates generally to a downhole oil well sensor housing having a compression seal assembly responsive to the external pressures within a subterranean bore-hole, and more particularly to a downhole oil well sensor housing having a sealing assembly configured to provide a compression seal around individual signal wires coupled to a downhole measurement sensor retained within the sensor housing.

2. Description of the Related Art

Various types of downhole equipment, such as pumps and similar devices, are used to move fluids from beneath the surface of the earth to the surface. Well known applications include oil and gas wells and water wells. A typical downhole arrangement would include a string composed of a series of tubes or tubing suspended from the surface. One type of well-known pump is a downhole electrical submersible pump. The electrical submersible pump either includes or is connected to a downhole motor which is sealed so that the whole assembly is submerged in the fluid to be pumped. The downhole motor is connected to a three-phase power source at the surface and operates beneath the level of fluid downhole in order to pump the fluid to the surface.

A long power cable from the surface equipment (˜500 to 2500 feet) generally provides power to both the downhole measurement sensor and the electrical submersible pump. The downhole measurement sensor is coupled to the electrical submersible pump and used to monitor certain downhole parameters, such as pressure and temperature, of a subterranean bore-hole.

In the common design of many downhole measurement sensors used in oil wells, each individual wire coupling the sensor to the associated submersible pump must be separately sealed due to issues of making the necessary cable splices between the leads associated with the signal conductors of the downhole measurement sensor. The ability to make these splices reliably can only be done on individually insulated wires, thus precluding the ability to utilize a single compression seal over the jacket of a multi-conductor cable into the downhole measurement sensor.

It is therefore desirable to provide a downhole oil well sensor housing having a compression seal assembly responsive to the external pressures within a subterranean bore-hole.

It is further desirable to provide a downhole oil well sensor housing having a sealing assembly configured to provide a compression seal around individual signal wires coupled to a downhole measurement sensor retained within the sensor housing.

It is still further desirable to provide a downhole oil well sensor housing having a plurality of seal assemblies configured to provide a pressure responsive, compression seal directly against the insulation of signal wires for a downhole measurement sensor therein.

Other advantages and features of the invention will be apparent from the following description and from the claims.

### BRIEF SUMMARY OF THE INVENTION

In general, in a first aspect, the invention relates to a sensor housing having a sensor housing body constructed of an internal passage with opposed ends. At least one of the ends of the sensor housing has a recess defined within an inner periphery of the sensor housing body. The sensor housing also includes a sealing assembly configured to provide a compression seal in response to external pressure applied the sensor housing body. The sealing assembly is constructed from an end plate, a retaining disc, a housing seal assembly and a wire seal assembly. The end plate has a medial face and a distal face, with the medial face configured to engage the recess. A housing seal groove is defined on an outer periphery of the end plate, and the end plate has at least one internal bore with a distal end terminating in a wire seal groove. The housing seal assembly is in sealing engagement with the housing seal groove of the end plate and the recess of the sensor housing body. The wire seal assembly is disposed within the wire seal groove of the end plate. The retaining disc is disposed within the sensor housing body and contacts the distal face of the end plate. The retaining disc also has at least one internal bore, which is coaxially aligned with and axially spaced from the internal bore of the end plate.

The recess of the sensor housing body can include a stop shoulder and a sealing surface. The housing seal assembly is in sealing engagement with the housing seal groove of the end plate and the sealing surface of the sensor housing body. The sensor housing body can be constructed as a generally cylindrical sensor housing body with the internal passage with opposed chamfered ends. The chamfered ends each have a recess with a stop shoulder, a cylindrical sealing surface and a circular retaining ring.

The sealing assembly directly seals against individual signal wires. The internal bore of the end plate and the internal bore of the retaining disc should each have an inner diameter slightly larger than an outer diameter of the individual signal wires. The wire seal assembly is disposed in sealing engagement with the individual signal wires. The housing seal assembly and/or the wire seal assembly can be constructed of an elastomeric or polymeric material, or blend thereof. The end piece may also be constructed of an elastomeric or polymeric material, or blend thereof, such as a polyetherimide (PEI) resin. The sensor housing body is constructed from a suitable downhole material, such as stainless steel.

The sensor housing may also include a retaining ring received within a circular retaining ring groove defined within the inner periphery of the sensor housing body. The retaining ring maintains the retaining disc in contact with the distal face of the end plate, and also maintains engagement between the wire sealing assembly and individual signal wires.

In general, in a second aspect, the invention relates to a downhole measurement tool. The tool includes a downhole measurement sensor capable of being coupled to an electric submersible pump using a multi-conductor cable having a plurality of individually insulated signal wires. The downhole measurement sensor has a transducer and a printed circuit board coupled to the pump using the individually insulated signal wires. The sensor of the downhole measurement tool is retained within a sensor housing. The sensor housing has a sealing assembly configured to provide a compression seal around each of the individually insulated signal wires in response to external pressure applied to the sensor housing.

The sensor housing of the downhole measurement tool can be constructed from a sensor housing body having an internal passage with opposed chamfered ends. Each of the ends has a recess defined within an inner periphery of the sensor housing body. The recess includes a stop shoulder and a sealing surface. The sealing assembly includes an end plate having a medial face and a distal face, with the medial face of the end plate configured to engage the stop shoulder. The end plate has a housing seal groove defined on an outer periphery of the end plate, and has a plurality of internal bores each having a distal end terminating with a wire seal groove. The sealing assembly also includes a housing seal assembly in sealing engagement with the housing seal groove of the end plate and the sealing surface of the sensor housing. Moreover, a wire seal assembly is disposed within the wire seal groove of the end plate, and is in sealing engagement with the individual signal wires. The sealing assembly also includes a retaining disc disposed within the sensor housing in contact with the distal face of the end plate. The retaining disc also has a plurality of internal bores which are coaxially aligned with and axially spaced from the internal bores of the end plate.

The sensor housing of the downhole measurement tool can also have a retaining ring received within a circular retaining ring groove defined within the inner periphery of the sensor housing. During usage, the retaining ring maintains the retaining disc in contact with the distal face of the end plate, and maintains engagement between the wire seal assembly and the individual signal wires.

### BRIEF DESCRIPTION OF THE DRAWINGS

FIG. 1 is a partial cutaway, exploded view of an example of a sensor housing body and a sealing assembly in accordance with an illustrative embodiment of the downhole oil well sensor housing having a compression seal assembly disclosed herein;

FIG. 2 is a top plan view of an example of a retaining disc secured within a sensor housing body in accordance with an illustrative embodiment of the invention disclosed herein;

FIG. 3 is a top plan view of an example of an end plate secured within a sensor housing body in accordance with an illustrative embodiment of the invention disclosed herein;

FIG. 4 is a cross-sectional view along line 4-4 of in FIG. 2 of an example of a downhole measurement tool in accordance with an illustrative embodiment of the invention disclosed herein.

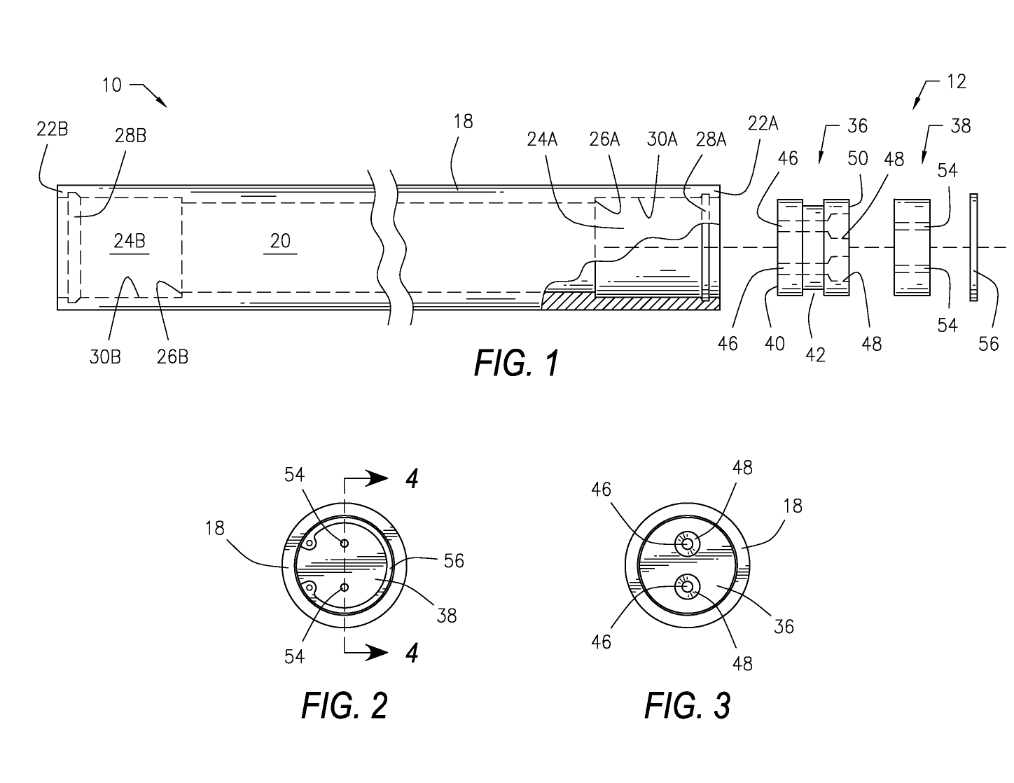

### DETAILED DESCRIPTION OF THE INVENTION

The devices and processes discussed herein are merely illustrative of specific manners in which to make and use this invention and are not to be interpreted as limiting in scope.

While the invention has been described with a certain degree of particularity, it is to be noted that many modifications may be made in the details of the construction and the arrangement of the elements and components of the devices and/or in the sequences and steps of the processes without departing from the scope of this disclosure. It is understood that the devices and processes are not limited to the embodiments set forth herein for purposes of exemplification.

The description of the invention is intended to be read in connection with the accompanying drawings, which are to be considered part of the entire written description of this invention. In the description, relative terms such as “front,” “rear,” “lower,” “upper,” “horizontal,” “vertical,” “above,” “below,” “up,” “down,” “top” and “bottom” as well as derivatives thereof (e.g., “horizontally,” “downwardly,” “upwardly” etc.) should be construed to refer to the orientation as then described or as shown in the drawings under discussion. These relative terms are for convenience of description and do not require that the machine be constructed or the process to be operated in a particular orientation. Terms, such as “connected,” “connecting,” “attached,” “attaching,” “join” and “joining” are used interchangeably and refer to one structure or surface being secured to another structure or surface or integrally fabricated in one piece.

In general, the invention relates to a sensor housing that is sealed in response to external pressure, in particular in oil wells where the pressures typically do not exceed about 1000 psig, and the maximum temperatures are about 100° C. Referring now to the figures of the drawings, wherein like numerals of reference designate like elements throughout the several views, the invention relates to a downhole oil well sensor housing 10 having a compression seal assembly 12 that is responsive to the external pressures within a subterranean bore-hole. The sealing assembly 12 of the sensor housing 10 seals directly against individual signal wires 14 coupled to a downhole measurement sensor 16 retained within the sensor housing 10. The sensor housing 10 may be constructed as a generally cylindrical housing body 18 defining an internal passage 20 with opposed chamfered ends 22A/B. The chamfered ends 22A and 22B may be symmetrical around the internal passage 20 of the housing body 18. Each chamfered end 22A and 22B of the sensor housing body 18 includes a recess 24A/B defined within the inner periphery of the sensor housing body 18 for receipt of the sealing assembly 12. The recess 24A/B includes a stop shoulder 26A/B and a circular retaining ring groove 28A/B with a cylindrical sealing surface 30A/B intermediate thereof. The sealing assembly 12 is secured within the recess 24A at one end 22A of the sensor housing body 18.

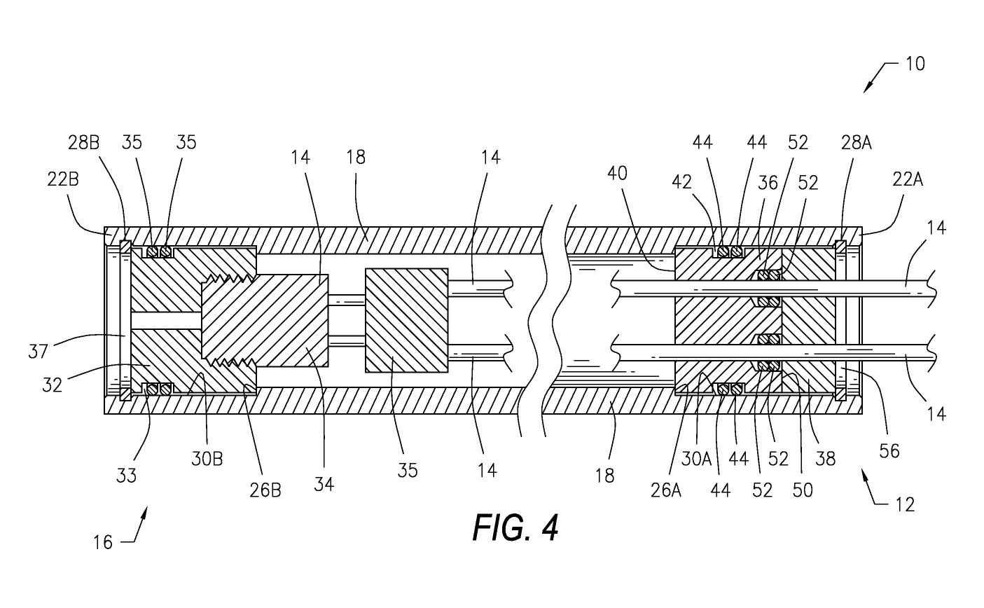

The downhole measurement sensor 16 is also housed within the sensor housing 10 and monitors the conditions within the oil well. The downhole measurement sensor 16 is secured within the recess 24B at the other end 22B of the sensor housing body 18. As exemplified in FIG. 4, the downhole measurement sensor 16 may be any suitable electronic downhole sensor (e.g., a thermometer or a pressure gauge) having a transducer 34 and a printed circuit board (PCB) 35. The downhole measurement sensor 16 is electrically coupled to the signal wires 14 using suitable cable splices. A retaining disc 32 is disposed within the sensor housing body 18 for contact with the stop shoulder 26B of the recess 24B. The retaining disc 32 includes a circular sealing groove 33 defined on an outer periphery of the retaining disc 32 for receipt of an annular sensor seal or seal assembly 35. A retaining ring 37 is received within the circular retaining ring groove 28B that is defined within the recess 24B along the inner periphery of the sensor housing body 18. The retaining ring 37 maintains the retaining disc 32 in position against the stop shoulder 26B and the transducer 34 of the downhole measurement sensor 16.

The sealing assembly 16 includes an end plate 36 and a retaining disc 38. The end plate 36 is disposed within the sensor housing body 18 and a medial face 40 of the end plate 36 contacts the stop shoulder 26A of the recess 24A. A circular housing sealing groove 42 is defined on an outer periphery of the end plate 36 for receipt of an annular housing seal or seal assembly 44. The housing seal assembly 44 is disposed in sealing engagement with the sealing surface 30A on the inner periphery of the recess 24A of the sensor housing body 18. The end plate 36 also includes internal bores 46 each having an inner diameter slightly larger than an outer diameter of the insulation of the individual signal wires 14 coupled to the downhole measurement sensor 16. A circular wire sealing groove 48 is disposed near a distal end of each of the internal bores 46 in the end plate 36 for receipt of an annular wire seal or seal assembly 52. The wire seal assembly 52 is disposed in sealing engagement with the insulation of the signal wires 14.

The retaining disc 38 is disposed within the sensor housing body 18 for contact with a distal face 50 of the end plate 36 of the sealing assembly 12. Similar to the end plate 36, the retaining disc 38 includes internal bores 54 having an inner diameter slightly larger than an outer diameter of the insulation of the individual signal wires 14. The internal bores 54 of the retaining disc 38 are coaxially aligned with and axially spaced from the internal bores 46 of the end plate 36.

A retaining ring 56 is received within the circular retaining ring groove 28 that is defined within the recess 24A along the inner periphery of the sensor housing body 18. The retaining ring 56 maintains the retaining disc 38 in position against the distal face 50 of the end plate 36 and maintains the wire sealing assembly 52 in engagement with the insulation of the signal wires 14.

The housing seal assembly 44 and the wire seal assembly 52 may be constructed of any suitable elastomeric or polymeric material, or a blend thereof, such as fluoroelastomer. Moreover, the housing seal assembly 44 and/or the wire seal assembly 52 can include one or more O-ring seals. The end piece 36 may be constructed of a suitable elastomeric or polymeric material, such as polyetherimide (PEI) resin, that withstands the chemicals the sensor 16 will be exposed to in the oil well. The sensor housing body 18 is constructed from any suitable material, such as stainless steel. The retaining disc 38 compresses during normal operating pressures (e.g., below about 1000 psig) and temperatures (e.g., below about 100° C.) against the distal face 50 of the end plate 36 causing the wire seal assembly 52 to seat against the insulation of the signal wires 14 in order provide the compression seal for the sensor housing 10. In addition, the housing seal assembly 44 and the sensor seal assembly 35 respectively seat against the cylindrical sealing surface 30A/B in the recess 24A/B of the sensor housing body 18.

Whereas, the devices and processes have been described in relation to the drawings and claims, it should be understood that other and further modifications, apart from those shown or suggested herein, may be made within the scope of the invention.

What is claimed is:

1. A sensor housing, comprising:
a sensor housing body comprising an internal passage with opposed ends, at least one of said ends comprising a recess defined within an inner periphery of said sensor housing body; and
a sealing assembly configured to provide a compression seal in response to external pressure applied to said sensor housing body, said sealing assembly comprising:
an end plate having a medial face and a distal face, said medial face of said end plate configured to engage said recess, said end plate comprising a housing seal groove defined on an outer periphery of said end plate, said end plate comprising an internal bore having a distal end terminating with a wire seal groove;
a housing seal assembly in sealing engagement with said housing seal groove of said end plate and said recess of said sensor housing body;
a wire seal assembly disposed within said wire seal groove of said end plate; and
a retaining disc disposed within said sensor housing body and in contact with said distal face of said end plate, said retaining disc comprising an internal bore coaxially aligned with and axially spaced from said internal bore of said end plate.

2. The sensor housing of claim 1 wherein said recess further comprises a stop shoulder and a sealing surface, and wherein said housing seal assembly is in sealing engagement with said housing seal groove of said end plate and said sealing surface of said sensor housing body.

3. The sensor housing of claim 1 wherein said sensor housing body further comprises a generally cylindrical sensor housing body comprising said internal passage with opposed chamfered ends, each of said chamfered ends comprising said recess having said stop shoulder, a cylindrical sealing surface and a circular retaining ring.

4. The sensor housing of claim 1 wherein said sealing assembly directly seals against individual signal wires.

5. The sensor housing of claim 4 wherein said internal bore of said end plate and said internal bore of said retaining disc each have an inner diameter slightly larger than an outer diameter of said individual signal wires.

6. The sensor housing of claim 4 wherein said wire seal assembly is disposed in sealing engagement with said individual signal wires.

7. The sensor housing of claim 1 further comprising a retaining ring received within a circular retaining ring groove defined within said inner periphery of said sensor housing body.

8. The sensor housing of claim 7 wherein said retaining ring maintains said retaining disc in contact with said distal face of said end plate.

9. The sensor housing of claim 7 wherein said retaining ring maintains engagement between said wire sealing assembly and individual signal wires.

10. The sensor housing of claim 1 wherein said housing seal assembly and/or said wire seal assembly is constructed of an elastomeric or polymeric material, or blend thereof.

11. The sensor housing of claim 1 wherein said end piece is constructed of an elastomeric or polymeric material, or blend thereof.

12. The sensor housing of claim 11 wherein said end piece is constructed of a polyetherimide (PEI) resin.

13. The sensor housing of claim 1 wherein said sensor housing body is constructed of stainless steel.

14. A downhole measurement tool, comprising:
a downhole measurement sensor capable of being coupled to an electric submersible pump using a multi-conductor cable having a plurality of individually insulated signal wires, said downhole measurement sensor comprising a transducer and a printed circuit board coupled to said pump using said individually insulated signal wires; and
a sensor housing retaining said downhole measurement sensor, said sensor housing comprising a sealing assembly configured to provide a compression seal around each of said individually insulated signal wires in response to external pressure applied to said sensor housing.

15. The downhole measurement tool of claim 14 wherein said sensor housing further comprises:
a sensor housing body comprising an internal passage with opposed chamfered ends, each of said ends comprising a recess defined within an inner periphery of said sensor housing body, said recess comprising a stop shoulder and a sealing surface; and
said sealing assembly configured to provide said compression seal in response to external pressure applied said sensor housing body, said sealing assembly comprising:
an end plate having a medial face and a distal face, said medial face of said end plate configured to engage said stop shoulder, said end plate comprising a housing seal groove defined on an outer periphery of said end plate, said end plate comprising an internal bore having a distal end terminating with a wire seal groove;
a housing seal assembly in sealing engagement with said housing seal groove of said end plate and said sealing surface of said sensor housing;
a wire seal assembly disposed within said wire seal groove of said end plate, said wire seal assembly disposed in sealing engagement with said individual signal wires; and
a retaining disc disposed within said sensor housing and in contact with said distal face of said end plate, said retaining disc comprising an internal bore coaxially aligned with and axially spaced from said internal bore of said end plate.

16. The downhole measurement tool of claim 14 wherein said sensor housing further comprises a retaining ring received within a circular retaining ring groove defined within said inner periphery of said sensor housing.

17. The downhole measurement tool of claim 16 wherein said retaining ring maintains said retaining disc in contact with said distal face of said end plate, and wherein said retaining ring maintains engagement between said wire seal assembly and said individual signal wires.

18. The downhole measurement tool of claim 14 wherein said housing seal assembly and/or said wire seal assembly and/or said end piece is constructed of an elastomeric or polymeric material, or blend thereof.

19. The downhole measurement tool of claim 14 wherein said sensor housing body is constructed of stainless steel.
